(19) United States
(12) Patent Application Publication
(10) Pub. No.: US 2010/0099487 A1
(43) Pub. Date: Apr. 22, 2010

(54) WAGERING GAME MACHINE FAN CONTROL AND MONITORING

(76) Inventors: Stephen A. Canterbury, Antioch, IL (US); Victor Mercado, Berwyn (IL)

Correspondence Address: SCHWEGMAN, LUNDBERG & WOESSNER/WMS GAMING, P.O. BOX 2938, MINNEAPOLIS, MN, 55402, US

(21) Appl. No.: 12/445,523

(22) PCT Filed: Nov. 1, 2007
(86) PCT No.: PCT/US07/23106

§ 371 Date: Apr. 14, 2009

Related U.S. Application Data
(60) Provisional application No. 60/864,055, filed on Nov. 2, 2006.
(60) Provisional application No. 60/911,937, filed on Apr. 16, 2007.

(51) Int. Cl. G06F 17/00

(52) U.S. Cl. 463/25; 463/47

(57) ABSTRACT

A computerized wagering game system includes a gaming module comprising gaming code which is operable when executed on to conduct a wagering game on which monetary value can be wagered, and includes a cooling module comprising two or more fans and a fan controller operable to control the speed of the two or more fans.

### RELATED APPLICATIONS

This patent application claims the priority benefit of U.S. Provisional Patent Application Ser. No. 60/864,055 filed Nov. 2, 2006 and entitled “FAN CONTROL AND MONITORING IN A WAGERING GAME MACHINE” and to U.S. Provisional Patent Application Ser. No. 60/911,937 filed Apr. 16, 2007 and entitled “FAN CONTROL AND MONITORING IN A WAGERING GAME MACHINE”, which applications are incorporated herein by reference.

### FIELD OF THE INVENTION

The invention relates generally to electronics cooling fans in wagering game machines, and more specifically to control of multiple cooling fans in computerized wagering game machines.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2006, 2007, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. It is not uncommon for audio voices to provide instruction and help, and to provide commentary on the wagering game being played. A variety of complex graphics and video capabilities are also often provided via one or more specialized graphics processors, including the ability to decode and render full motion video, and to render complex three-dimensional graphics. Specialized graphics processors are often implemented to perform such functions, so that they can be specifically tailored to graphics rendering applications, and so that the main system processor remains free to perform other tasks during graphics rendering.

Modern wagering game systems typically include a variety of types of semiconductor devices and electronics, including general purpose processors such as those found in many personal computers, graphics processors designed to provide detailed animation and three-dimensional graphics, and other sophisticated electronics devices. Such devices often produce a great deal of heat, and must be cooled to ensure proper operation. For this reason, it is not uncommon for components such as the processor or graphics processor to have a fan attached to a heatsink mounted on the semiconductor package, or for the wagering game cabinet to have a fan to expel hot air or to suck cool air into the enclosure.

But, because the wagering games operate under a variety of conditions and configurations, it is difficult to provide an optimum fan configuration. The heat generated by various components can change over time during operation, and the electronics configuration and operating environment of one machine may be different from the next. For these and other reasons, it is desirable to control the cooling functions of a wagering game machine.

### SUMMARY

One example embodiment of the invention comprises a computerized wagering game system including a gaming module comprising gaming code which is operable when executed on to conduct a wagering game on which monetary value can be wagered. The wagering game also includes two or more cooling fans, and a cooling module comprising a fan controller operable to control the speed of the two or more fans via the same fan controller. In further embodiments, the speed of the two or more fans is based on the temperature observed by one or more temperature sensors coupled to the fan controller. The fan controller in some embodiments applies an algorithm to determine fan speed to improve power consumption or noise characteristics of the cooling system.

### BRIEF DESCRIPTION OF THE FIGURES

FIG. 1 shows a computerized wagering game machine, as may be used to practice some example embodiments of the invention.

FIG. 2 is a block diagram of a wagering game machine, consistent with some example embodiments of the invention.

FIG. 3 is a block diagram of a cooling system within a computerized wagering game system, consistent with some example embodiments of the invention.

FIG. 4 is a flowchart of a method of operating a wagering game system, consistent with some example embodiments of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention comprises a computerized wagering game system including a gaming module comprising gaming code which is operable when executed on to conduct a wagering game on which monetary value can be wagered, and a cooling module comprising a fan controller operable to control the speed of the two or more fans. In further embodiments, the speed of the two or more fans is based on the temperature observed by one or more temperature sensors coupled to the fan controller. The fan controller in some embodiments applies an algorithm to determine fan speed to improve power consumption or noise characteristics of the cooling system.

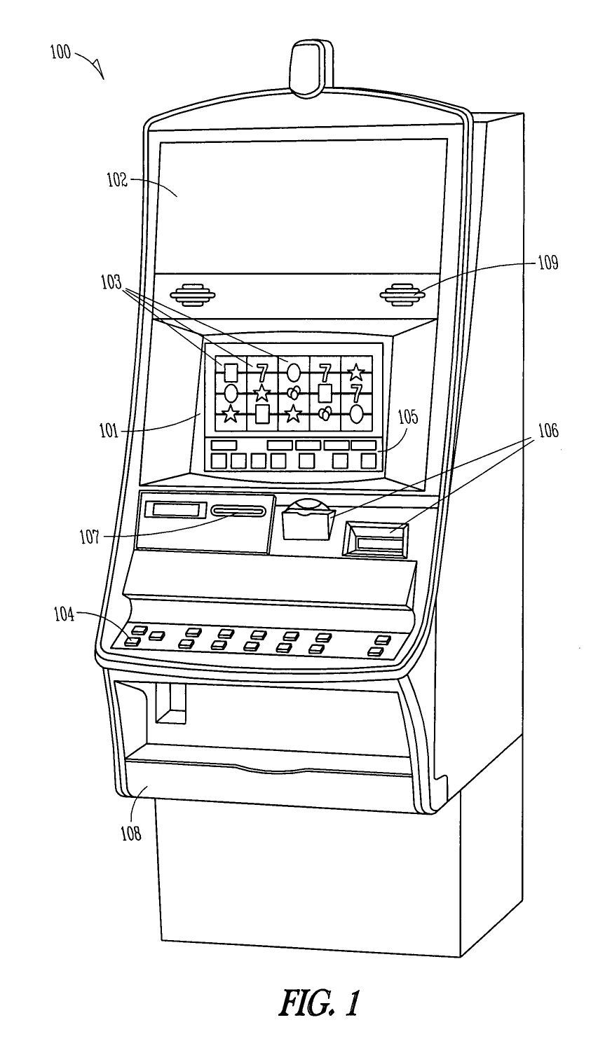

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. In some further embodiments, additional displays such as a bonus game display or top box display 102 are further operable to display electronically provided information to a wagering game player. Alternate embodiments of the invention will have other game indicators, such as mechanical reels instead of the video graphics reels shown at 103 that comprise a part of a video slot machine wagering game.

A wagering game is implemented using software within the wagering game, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The wagering game implemented via the loaded software takes various forms in different wagering game machines, including such well-known wagering games as reel slots, video poker, blackjack, craps, roulette, or hold 'em games. In some further embodiments, a secondary game or bonus game is displayed on the secondary display 102, or other information such as progressive slot information or other community game information is displayed.

The wagering game is played and controlled with inputs such as various buttons 104 or via a touchscreen overlay to video screen 101. The touchscreen is used in some embodiments to display virtual buttons, which can have unique functions in some embodiments, or can duplicate the functions provided by the mechanical buttons 104 in other embodiments. In some alternate examples, other devices such as virtual buttons 105 on the touchscreen display or a pull arm are employed to provide other input interfaces to the game player, such as to initiate reel spin. The player interface components are in this example contained within or mechanically coupled to the wagering game system, but in other embodiments will be located outside the wagering game system cabinet such as by a wired or wireless electronic connection to the wagering game system.

Monetary value is typically wagered on the outcome of the games, such as with tokens, coins, bills, or cards that hold monetary value. The wagered value is conveyed to the machine such as through a changer 106 or a secure user identification module interface 107, and winnings are returned such as via a returned value ticket, a stored value card, or through the coin tray 108. Sound is also provided through speakers 109, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

In other embodiments, the computerized wagering game system takes one or more other forms, such as a mobile or portable wagering game device, a server-based wagering game device, or a networked wagering game system. These other computerized wagering game system embodiments need not contain all features of the wagering game system of FIG. 1, which does not limit the scope of a computerized wagering game but is provided as an example only.

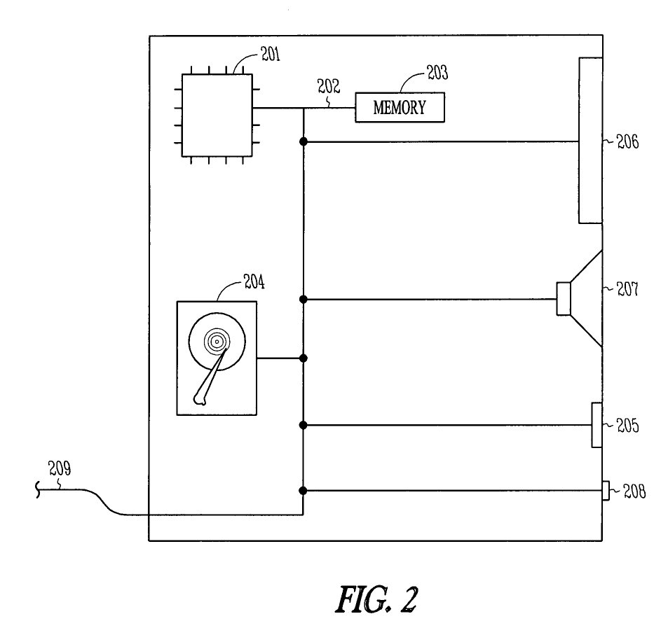

FIG. 2 shows a block diagram of an example embodiment of a wagering game system. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or HD-DVD storage in the wagering game system.

The bus 202 also couples the processor and components to various other components, such as a value acceptor 205, which is in some embodiments a token acceptor, a card reader, or a biometric or wireless player identification reader. A touchscreen display 206 and speakers 207 serve to provide an interface between the wagering game system and a wagering game player, as do various other components such as buttons 208, pullarms, and joysticks. A network connection 209 couples the wagering game system to other wagering game machines and to a wagering gape server, such as to provide downloadable games or to provide accounting, player tracking, or other functions. These components are located in a wagering game machine cabinet such as that of FIG. 1 in some embodiments, but can be located in multiple enclosures comprising a wagering game system or outside a wagering game machine cabinet in other embodiments, or in alternate forms such as a wireless or mobile device.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual intervention, and various combinations thereof.

Various components of the wagering game machine, such as the processor 201 and the graphics processor that drives touchscreen display 206, can produce a significant amount of heat, and often require some form of cooling to operate properly. Modern processors, for example, may generate on the order of a hundred Watts of heat when under full load, and would literally melt and stop operating in the absence of some form of active cooling such as a fan or heat pipe. Other components such as graphics processors and other high-performance semiconductor devices can produce a similar amount of heat, which is typically dissipated into the air. Cooling devices such as fans are typically therefore attached to or mounted near heat sinks, which are typically mounted in physical contact with the semiconductor device to be cooled to facilitate dissipation of the generated heat. Thermally conductive material such as metal-bearing grease or ceramic-bearing grease is often applied between the semiconductor and the heatsink, to mediate small surface imperfections such as variations in flatness between the heat sink and semiconductor device. Further, fans are also sometimes installed in the cabinet or enclosure of a wagering game machine, to assist in expelling heat generated inside the cabinet or to bring cool air into the enclosure.

These fans are typically plugged in to a power source such as a computer's five volt or twelve volt power supply, and operate continuously. In some more sophisticated examples, the processor includes a temperature sensor coupled to a local control circuit, which in turn is operable to control the fan attached to the processor and the control circuit. But while such single-fan local control solutions enable some degree of power savings and noise control by allowing the processor fan to operate at reduced speed when the processor temperature is low, they do little to ensure efficient cooling of the wagering game cabinet, or to ensure efficient operation of the cooling system as a whole.

Some embodiments of the invention therefore address coordinated control of multiple fans in a wagering game system, such as control of a processor fan and an enclosure fan based on the same controller and using the same information to control the fans. In one example, the processor fan and cabinet fan are coupled to a controller, which is also coupled to receive the processor temperature and the ambient temperature inside the cabinet. The processor fan speed is dependent on both the processor temperature and the ambient cabinet temperature, while the cabinet fan speed is dependent on the ambient temperature inside the wagering game enclosure. In one more detailed example, it is known that the processor fan cools the processor more efficiently if the difference between the processor temperature and enclosure temperature is greater. The controller therefore operates the cabinet cooling fan in conjunction with the processor fan to ensure efficient cooling of the processor, while retaining the ability to reduce the speed of both fans for energy efficient operation and to control noise when higher fan speeds are not required.

FIG. 3 shows a block diagram of a wagering game cooling system, consistent with an example embodiment of the invention. A general-purpose processor 301, such as an Intel™ x86-compatible processor is thermally coupled to a heat sink 302, which is configured in close proximity to a fan 303 configured to move air through the heat sink and dissipate heat from the processor. The example shown here shows air being sucked in from above the fan and forced into the heatsink, but the fan in other embodiments will move air in the other direction or be configured in another way relative to a heat sink, the processor, a heat pipe, or other components.

A graphics processor 304 is similarly equipped with a heat sink 305 and a cooling fan 306. Both cooling fans 303 and 306 are controlled via the controller 307, and both processors 301 and 304 provide temperature information to the controller 307. The controller is further coupled to a thermometer 308 operable to measure the ambient temperature inside the wagering game machine cabinet, and to an external thermometer 309 operable to measure the air temperature outside the cabinet. Both cooling fans 303 and 306 are controlled via the controller 307, and both processors 301 and 304 provide temperature information to the controller 307. Cooling fan 310 is located in the wagering game machine cabinet or enclosure, and is operable to move cool air into the cabinet or to blow heated air outside the cabinet. In further embodiments, multiple cabinet fans are used, such as using one fan to suck cool air into the cabinet while the other fan blows heated air out of the cabinet.

The fan controller 307 is in various embodiments hardware, software, or a combination of hardware and software. In one example, the fan controller comprises hardware to power the fans and to detect and report the speed of the fans and various temperatures to the computer system, along with software executing on the system processor 201 to control the fan speed based on the observed temperatures and fan speed.

In operation, the thermometers 301 and 304 each measure the temperature of their respective processors and provide the temperature data to the controller. Similarly temperature sensor or thermometer 308 provides the controller with the internal temperature of the wagering game cabinet, and thermometer 309 provides the controller with the temperature outside the wagering game cabinet. Each of fans 303, 306, and 310 are powered by the controller, and their operation and speed are under the control of the controller. Further, each of the fans provides the controller a signal such as a third-wire tachometer signal indicating the rotational speed of the fan, and evidencing proper operation of the fan. The controller itself takes various forms in various embodiments of the invention, including software, hardware, and various combinations of software and hardware.

The controller uses the temperature information and speed information from the fans to control the temperature of the processors 301 and 304, and to control the ambient temperature inside the wagering game cabinet. In one example embodiment, the cabinet fan is off and the processor fan operates at a low setting when the computerized wagering game system is first started. As the general purpose processor heats up and reaches a threshold temperature, the fan 303 begins to spin faster to maintain the processor temperature at or below a desired level. The processor fan 303′s speed is dependent in part on the ambient temperature inside the cabinet as measured by the thermometer 308, as the processor fan will need to run faster to maintain a desired processor temperature if the ambient temperature inside the cabinet is higher.

For this reason, the cabinet fan 310 also operates faster as the difference between the external cabinet temperature as measured by the external thermometer 309 and the internal thermometer 308 becomes larger, ensuring that the air inside the wagering game cabinet is kept sufficiently cool for dissipating heat from the processors 301 and 304. A wagering game cabinet such as that shown in FIG. 1 may be installed in a variety of locations, including cool or warm locations, and locations with or without moving air. Further, the characteristics of the location of even a single wagering game machine may vary with the time of day, with the seasons, or for other reasons. Also, the wagering game system's configuration may be different from the next system, such as where one generation of a wagering game machine has a new graphics processor that provides greater functionality but that generates more heat than the graphics processor previously used. The controller 307 of this example therefore monitors both the internal cabinet temperature via thermometer 308 and the external air temperature via thermometer 309, and operates fan 310 as needed.

In a further embodiment, the controller 307 applies an algorithm designed to minimize or limit the amount of power consumed in operating the cooling fans, seeks to minimize or control the amount of fan noise produced, or seeks to strike a balance between minimizing or controlling both fan noise and power consumed. The algorithm itself is in some embodiments based on preprogrammed fan characteristics and other physical and electrical parameters of the processors and cooling system, while in other embodiments it is learned as a result of measurements observed during cooling system operation. For example, the ability of a fan to cool a processor may be learned, including learning how rapidly the fan must spin to cool the processor at a given rate depending on the temperature difference between the processor and ambient air temperature inside the wagering game system. Similarly, the controller 307 in another embodiment will learn what combinations of processor fan 303 speed and cabinet fan 310 speed will result in the desired low power consumption and perceived fan noise while maintaining the processor temperature at or below desired levels.

The algorithm is therefore in some embodiments based on known or observed fan characteristics. In another example, the fan speed is based at least in part on the performance or characteristics of other fans. If one wagering game cabinet fan begins to fail, for example, or fails completely, other wagering game cabinet fans (not pictured in FIG. 3) will operate at a faster rate to compensate.

In another example embodiment, one or more of the fans will change rate to anticipate changes in temperature. For example, if the wagering game machine changes state from displaying a static image to rendering complex three-dimensional images as a part of the wagering game presentation, it can be reasonably anticipated that the graphics processor 304 will generate more heat as it performs more calculations. The controller 307 will therefore operate the graphics processor 304's fan 306 at a faster rate even before the graphics processor becomes particularly hot. Anticipating a change in temperature and operating one or more fans in response to an anticipated change not yet observed can reduce the speed with which the temperature changes, and reduce stress and the risk of overheating the processor or other wagering game system component. In another example, the fan rate is changed gradually when possible, minimizing the perceived change in noise level as the fans change speed.

The controller is in some embodiments also operable to monitor the fans, such as by observing the amount of current drawn by the fan in operation or by monitoring a tachometer signal provided by the fan. The speed of a fan can be used along with various temperature measurements such as processor temperature and ambient temperature to estimate the heat transfer efficiency of the cooling system, and can in additional examples be used to monitor the operational status and health of the fans. In one example, a tachometer wire is monitored to measure fan speed. If the fan isn't running, no fan speed will be observed, and the wagering game system can enter a tilt condition or shut down if needed to protect the components to be cooled by the failed fan. If the fan speed observed via the tachometer is slower than fan speeds previously observed when the fan was supplied with the same voltage, the fan can be observed to be operating less efficiently than it has previously operated, which may be a sign of aging or impending failure. Some embodiments will therefore generate an error message indicating service is required if a fan's performance falls below a certain threshold, such as by becoming 20% less efficient than its anticipated or original operational efficiency.

Similarly, fan current can be observed such as where there is no tachometer signal available. Current level in one embodiment fluctuates as the fan spins, such that fluctuations in the current drawn by the fan can be used to calculate the fan speed. In other embodiments, the amount of current drawn at a certain fan speed is observed to detect or predict fan aging or failure. For example, a fan that is stuck may draw current in excess of what is expected for a certain fan supply voltage, or may be stuck in a position such that little or no current is drawn. Similarly, modest changes in current drawn at a certain speed can indicate that a fan is wearing out, and that its efficiency is changing. Some errors, such as detecting that a fan is no longer operating at or near its original efficiency, are used in this example to generate a warning message indicating that the fan is still operational, but that it should be replaced as a part of normal maintenance and service. Other problems, such as a processor fan that has failed entirely, may result in an immediate shutdown or severely restricted operation of the processor and generation of a tilt condition, so that the processor is not destroyed. In a further example, the wagering game's state is automatically stored in nonvolatile storage before the wagering game machine stops operation or generates a tilt condition, so that the game state and any winnings or credits won can be preserved. It is anticipated in some such situations that the value of preserving the wagering game state is more important than preserving the protected hardware component.

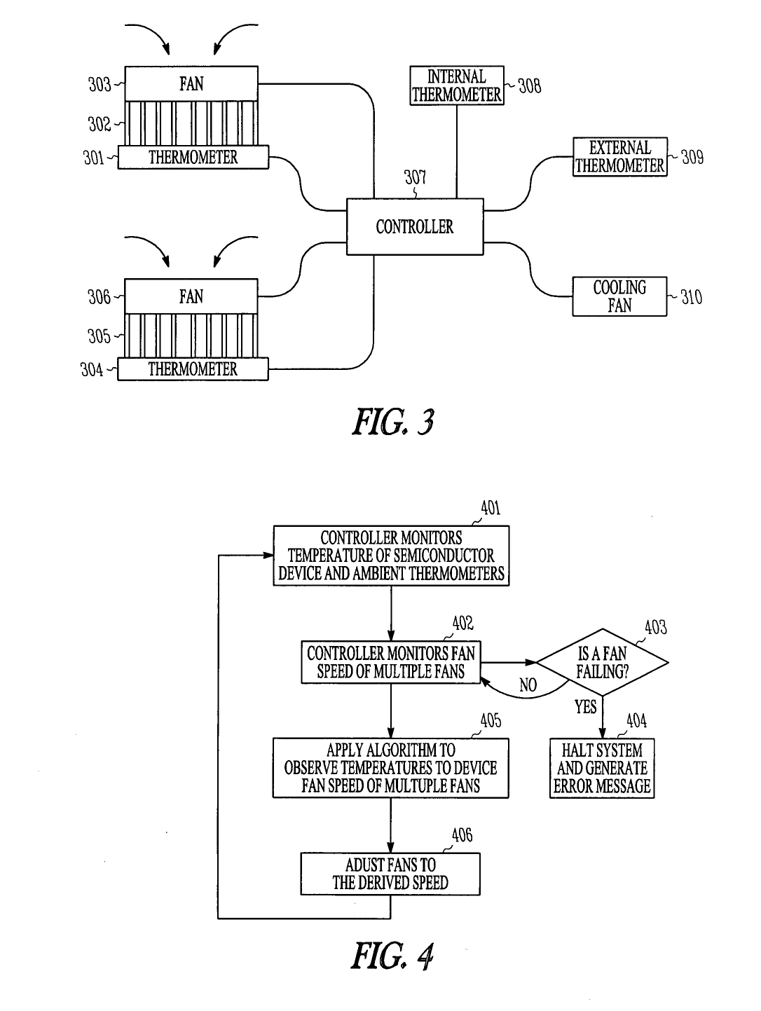

FIG. 4 is a flowchart, illustrating a variety of functions provided by the controller 307 in one example embodiment of the invention. At 401, the wagering game system starts operation, and monitors the temperature of processors 301 and 304, and the thermometers 308 and 309. The wagering game system also monitors fan speed at 402 via third-wire tachometer leads provided by each of the fans 303, 306, and 310. A process 403 uses the fan speed monitor data to determine whether a fan is failing or has failed, so that appropriate action can be taken. For example, if a fan is operational but is failing, an error message may be generated but the wagering game machine may remain operational. If a fan has failed, the wagering game machine may be halted as shown at 404, and an error message displayed indicating the malfunction. In a further embodiment, fan health is not based solely on observed fan speed in normal operation, but is determined based on operation of the fan at a reference voltage such as full power, such that the fan's characteristics can be tracked over time.

Meanwhile, an algorithm uses the temperature data observed at 401 to derive the desired fan speed for multiple fans at 405, such as for a processor fan and a cabinet fan, to efficiently move heat away from the processor and into the environment. In a further embodiment, other characteristics such as observed fan characteristics are incorporated into the algorithm, including fan speed at a given voltage and the fan's efficiency at cooling or moving air at various fan speeds. The algorithm is in some embodiments a mathematical formula used to calculate desired fan speeds, while in other examples the algorithm is applied via other methods such as a lookup table.

The fans are adjusted to the derived speeds at 406 via the controller, such as by changing the power signal sent to the fans. In some examples, the fan supply voltage is altered such as when a DC fan is used, while in other embodiments a fan power signal pulse rate is changed, such as when an AC fan is used. The process resumes monitoring temperature at 401 and fan speed at 402, and continues the process of making adjustments to the speed of multiple fans based on an applied algorithm during system operation.

In another example context in which various embodiments of the invention may operate, cooling airflow may be provided with limited or no moving parts.

One such example is use of what is sometimes known as a thermal pile or Josephson Peltier effect device. When electric current passed through it produce one side that is cool and the other side is warm. This method still requires that some air movement or exposure is needed to remove the heat from the warm side, but this can be as little as exposure to the cabinet, or to a vent. The heated air in some embodiments will cause air to move within its environment or within a vent itself, requiring no fans or other mechanical devices to move air. Minimal mechanical movement of air, such as via a small vent fan, can enhance the efficiency of some such methods while still consuming significantly less power than traditional full-sized fans.

Peltier effect devices and some other thermoelectric cooling device use the Peltier effect to create a heat difference between a junction of two dissimilar materials. When embodied as a cooler or heater, heat that is transferred from the cold side of the junction to the hot side of the junction can be moved away by thermal lift, such as by use of a heat sink and a vent, creating its own cooling air movement. This process consumes electrical energy to power the Peltier junction, but does not require mechanical moving parts.

The effectiveness of a thermoelectric device like a Peltier effect device at moving the heat away from the cold side is dependent upon the amount of current provided and how well the heat from the hot side can be removed. They can also be used to generate electricity if a temperature difference is maintained between the two sides. Further, because there are no moving parts, Peltier effect devices are relatively maintenance free.

In another example, a device called an ion pump is used to provide cooling to a semiconductor device or other element. An electron emitter emits ions that are propelled to the collector surface through the electric field difference between the emitter and collector, and the charge on the emitted ions. As the ions move from emitter to collector, they create a stream of fast-moving air, such as may be blown across the surface of a semiconductor device or across a heat sink to cool the device. The airflow can be controlled by controlling the emitter voltage, and the number and energy of ions that are emitted from the emitter tip or tips. Various nano-scale emitters, such as arrays of carbon nanotube emitters, can be used in some embodiments to provide significant ion emitting capability, and significant airflow with relatively little current consumed.

Airflow is believed to be created by collision or friction of the ions streaming between the emitter and collector with other air molecules. Transfer of momentum occurs as a result of such collisions or friction, causing a stream of air moving from the emitter to the collector. A similar effect has long been considered as a spacecraft propulsion method, in which ions expelled from an emitter have low mass but very high energy, propelling the spacecraft in the opposite direction from the emitted ions. Ionic propulsion of air is different in that the ion force is not primarily used to react against the emitter, but in that the ions collide with air molecules and propel them in the direction of ion movement, creating an air stream that can be used to propel, lift, move, or cool an object.

Both ion pumps and thermoelectric or Peltier effect devices can be used as a fan in various embodiments of the invention, or can be combined with one another or with traditional mechanical fans to create a cooling effect. In one such example, the various methods of the present invention are applied to independently control an ion pump device operating as a fan to move air across a heat sink, where the heat sink comprises a Peltier junction configured such that its cool side cools a semiconductor device while its hot side is thermally coupled to the heat sink.

The examples presented here illustrate how a wagering game system can operate multiple fans based on temperature readings, such as semiconductor device temperature readings and ambient temperature readings. In controlling multiple fans via the same controller or in using multiple temperature readings to determine fan rates, more efficient operation of the cooling system can be achieved. Further, various embodiments also facilitate compensation for a failed fan or other cooling system component, and application of an algorithm to obtain desired performance under a variety of fan and temperature conditions. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module comprising gaming code which is operable to present a wagering game on which monetary value can be wagered;
two or more cooling fans; and
a cooling module comprising a fan controller operable to control the speed of the two or more fans via the same fan controller.

2. The computerized wagering game system of claim 1, wherein the fan controller is operable to control the speed of the two or more fans based on temperature readings from two or more temperature sensors.

3. The computerized wagering game system of claim 2, wherein the temperature sensors comprise at least one of a semiconductor device temperature sensor and an ambient air temperature sensor, and the two or more cooling fans comprise at least one of a semiconductor device fan and an enclosure fan.

4. The computerized wagering game system of claim 1, wherein the fan controller controls the speed of at least one of the two or more fans via an algorithm to provide improved power efficiency.

5. The computerized wagering game system of claim 1, wherein the fan controller controls the speed of at least one of the two or more fans via an algorithm to provide improved noise performance.

6. The computerized wagering game system of claim 1, wherein the speed of the two or more fans is controlled based on at least one of known or measured fan characteristics.

7. The computerized wagering game system of claim 1, wherein the speed of at least one fan is dependent on the speed of at least one other fan.

8. The computerized wagering game system of claim 1, the fan controller further operable to monitor at least one of the two or more fans for proper fan operation.

9. The computerized wagering game system of claim 8, wherein monitoring the at least one fan for proper operation comprises monitoring at least one of current or fan speed at a specific operating voltage.

10. A computerized wagering game system, comprising:
a gaming module comprising gaming code which is operable to present a wagering game on which monetary value can be wagered;
two or more cooling fans; and
a cooling module comprising a fan controller operable to monitor the temperature of two or more locations in the wagering game system via the same fan controller, and further operable to control the speed of at least one fan based on the two or more temperatures.

11. A method of operating a computerized wagering game system, comprising:
presenting a wagering game on which monetary value can be wagered;
monitoring the temperature of two or more locations in the wagering game system via the same fan controller; and
controlling the speed of at least one fan via the fan controller based on the two or more temperatures.

12. A method of operating a computerized wagering game system, comprising:
presenting a wagering game on which monetary value can be wagered; and
controlling the speed of two or more fans via the same fan controller.

13. The method of operating a computerized wagering game system of claim 12, wherein controlling the speed of at least one of the two or more fans is performed via an algorithm to provide improved power efficiency.

14. The method of operating a computerized wagering game system of claim 12, wherein controlling the speed of at least one of the two or more fans is performed via an algorithm to provide improved noise performance.

15. The method of operating a computerized wagering game system of claim 12, wherein at least one of the two or more fans comprises a cabinet fan, and the speed of at least one cabinet fan is based on the temperature inside the cabinet and the temperature outside the cabinet.

16. The method of operating a computerized wagering game system of claim 12, wherein at least one of the two or more fans comprises a semiconductor device cooling fan, and the speed of the at least one semiconductor device cooling fan is based on the temperature of a semiconductor device being cooled by the fan and the temperature of the air in the semiconductor device's environment.

17. The method of operating a computerized wagering game system of claim 12, wherein controlling the speed of two or more fans via the same fan controller is based on temperature readings from two or more temperature sensors.

18. The method of operating a computerized wagering game system of claim 12, wherein the speed of at least one fan is dependent on the speed of at least one other fan.

19. The method of operating a computerized wagering game system of claim 12, further comprising monitoring at least one of the two or more fans for proper fan operation.

20. The method of operating a computerized wagering game system of claim 19, wherein monitoring the at least one fan for proper operation comprises monitoring at least one of current or fan speed at a specific operating voltage.
